(19) United States
(12) Patent Application Publication
(10) Pub. No.: US 2004/0112522 A1
(43) Pub. Date: Jun. 17, 2004

(54) Automated methods for making screen assemblies for vibratory separators

(76) Inventors: Kerry T. Ward, Cypress, TX (US); Thomas C. Adams, Hockley, TX (US); Kenneth W. Seyffert, Houston, TX (US); David Wayne Largent, Cleveland, TX (US); David L. Schulte JR., Broussard, LA (US); Vincent D. Leone, Houston, TX (US); Jeffrey E. Walker, Houston, TX (US); Charles N. Grichar, Houston, TX (US); Guy L. McClung III, Spring, TX (US)

Correspondence Address: Guy McClung, PMB 347, 16690 Champion Forest Drive, Spring, TX, 77379-7023, US

(21) Appl. No.: 10/649,316

(22) Filed: Aug. 27, 2003

Related U.S. Application Data
(63) Continuation-in-part of application No. 10/236,050, filed on Sep. 5, 2002.
Application No. 10/236,050 is a continuation-in-part of application No. 10/210,891, filed on Jul. 31, 2002.
Application No. 10/210,891 is a continuation-in-part of application No. 10/037,474, filed on Oct. 19, 2001, now Pat. No. 6,669,985.
Application No. 10/037,474 is a continuation-in-part of application No. 09/603,531, filed on Jun. 27, 2000, now Pat. No. 6,450,345.
Application No. 09/603,531 is a continuation-in-part of application No. 09/517,212, filed on Mar. 2, 2000, now Pat. No. 6,565,698.
Application No. 09/517,212 is a continuation-in-part of application No. 09/454,722, filed on Dec. 4, 1999, now abandoned.
Application No. 09/454,722 is a continuation-in-part of application No. 09/390,231, filed on Sep. 3, 1999, now Pat. No. 6,325,216.
(63) Continuation-in-part of application No. 10/210,891, filed on Jul. 31, 2002.
(63) Continuation-in-part of application No. 10/087,025, filed on Oct. 19, 2001.
(63) Continuation-in-part of application No. 09/707,277, filed on Nov. 6, 2000, now Pat. No. 6,581,781.
Application No. 09/707,277 is a continuation-in-part of application No. 09/183,004, filed on Oct. 30, 1998, now Pat. No. 6,186,337.

(51) Int. Cl. B32B 31/00; B32B 7/14; B07B 1/28

(52) U.S. Cl. 156/290; 156/291; 209/319

(57) ABSTRACT

Methods for making frames for screen assemblies for vibratory separators, and screen assemblies with such frames, the methods, in certain aspects, including making a frame support for a screen assembly for a vibratory separator (e.g. but not limited to with robotic welding apparatus), moving the frame support to cleaning apparatus to clean the frame support, heating the frame support, moving the heated frame support to coating apparatus, coating the frame support in the coating apparatus with protective material, allowing the coated frame support to cool so that the protective material sets, moving of the frame support in one aspect done by mechanical movement apparatus; and, in certain aspects, adding screening material to the frame to produce a screen assembly.

### RELATED APPLICATIONS

This is a continuation-in-part of U.S. application Ser. No. 10/236,050 filed Sep. 5, 2002 which is a continuation-in-part of U.S. application Ser. No. 10/210,891 filed Jul. 31, 2002, which is a continuation-in-part of U.S. application Ser. No. 10/037,474 filed Oct. 19, 2001, which is a continuation-in-part of U.S. application Ser. No. 09/603,531 filed Jun. 27, 2000 (issued as U.S. Pat. No. 6,450,345 on Sep. 17, 2002) which is a continuation-in-part of U.S. application Ser. No. 09/517,212 filed Mar. 2, 2000 (issued as U.S. Pat. No. 6,565,698 on May 20, 2003) which is a continuation-in-part of U.S. application Ser. No. 09/454,722 filed on Dec. 4, 1999 which is a continuation-in-part of U.S. application Ser. No. 09/390,231 filed Sep. 3, 1999; and this application is a continuation-in-part of U.S. application Ser. No. 10/210,891 filed Jul. 31, 2002, Ser. No. 10/087,025 filed Oct. 19, 2001, and Ser. No. 09/707,277 filed Nov. 06, 2000 which is a continuation-in-part of U.S. application Ser. No. 09/183,004 filed Oct. 30, 1998 (issued as U.S. Pat. No. 6,186,337 on Feb. 13, 2001)—all of which applications and patents are incorporated herein in their entirety for all purposes and with respect to all of which the present invention claims priority under the Patent Laws.

### BACKGROUND OF THE INVENTION

1. Field Of The Invention

The present invention is directed to methods for making screen assemblies for vibratory separators and shale shakers and to screen assemblies made by such methods.

2. Description of Related Art

Various prior art vibratory separators and shale shakers employ screen assemblies to separate components of materials. In many prior art screen assembly manufacturing operations tedious individual steps are carried out with many of the steps involving labor-intensive manual manipulation and handling of screen assembly components and manual and/or mechanized movement of screen assembly components and of screen assemblies in various stages of manufacture from one station to another and, often, from one location to another location. Manual procedures are also subject to typical non-uniformities in finished products and to a certain amount of out-of-acceptable tolerance, and therefore rejected, screen assemblies.

### SUMMARY OF THE PRESENT INVENTION

The present invention, in certain aspects, discloses automated methods for producing a screen assembly for a vibratory separator and for making screen assemblies with such frames.

In certain aspects such a method includes producing with robotic welding apparatus a frame for a screen assembly; producing with a robotic punching apparatus a grid or perforated plate for a screen assembly; moving with mechanized movement apparatus the frame and the grid to a cleaning system, e.g., a sand blasting apparatus; emplacing a combination of the grid and frame in a heating apparatus; and heating the frame-grid combination there; coating the heated frame-grid combination with powderized adhesive material, e.g., epoxy powder (e.g., but not limited to, using a fluidized bed system or an electrostatic application system); cooling the coated frame-grid combination to allow the epoxy to set and harden; optionally painting and/or applying additional wear-resistant coatings; and connecting one, two, three or more layers of mesh and/or screening material to the frame to form a screen assembly; and, optionally adhering, gluing, and/or sewing the layers of mesh and/or screening material together and/or to the frame. In certain aspects to such a screen assembly, with or without a frame, a perforated plate or strip support is used. When a perforated plate or strip support is used, it can be processed through the cleaning, heating, coating, and/or painting etc. steps as described above.

Movement apparatus for moving the screen assembly components between steps of methods according to the present invention are, in some aspects, like the movement systems for those used for moving finished dry cleaning and laundry in cleaning facilities; or conveyor belt apparatus.

It is, therefore, an object of at least certain preferred embodiments of the present invention to provide:

New, useful, unique, efficient, non-obvious systems and methods for automatically producing a frame for a screen assembly for a vibratory separator and/or a screen assembly made by such methods;

Such systems and methods in which the vibratory separator is a shale shaker for treating drilling fluid with drilled cuttings, debris, etc therein and the screen assemblies are able to withstand vibratory forces imparted thereto by vibration apparatus of the shale shaker;

Such systems and methods which reduce the amount of manual labor needed to produce a frame and a screen assembly;

Such systems and methods which produce a relatively more uniform screen assembly, reduce the incidence of rejected screen assemblies, and reduce the cost of production; and

New, useful, unique, efficient, and nonobvious shale screen assemblies for shale shakers and vibratory separators using screen assemblies made by such methods.

The present invention recognizes and addresses the previously-mentioned problems and long-felt needs and provides a solution to those problems and a satisfactory meeting of those needs in its various possible embodiments and equivalents thereof. To one of skill in this art who has the benefits of this invention's realizations, teachings, disclosures, and suggestions, other purposes and advantages will be appreciated from the following description of preferred embodiments, given for the purpose of disclosure, when taken in conjunction with the accompanying drawings. The detail in these descriptions is not intended to thwart this patent's object to claim this invention no matter how others may later disguise it by variations in form or additions of further improvements.

### DESCRIPTION OF THE DRAWINGS

A more particular description of certain embodiments of the invention may be had by references to the embodiments which are shown in the drawings which form a part of this specification.

FIG. 1 is a schematic view of a method according to the present invention.

FIGS. 2-6 are perspective views of systems useful in methods according to the present invention.

FIG. 7D is a top view of a screen assembly made by methods according to the present invention. FIG. 7A is a top view of a frame of the screen assembly of FIG. 7D. FIG. 7B is a top view of a grid of the screen assembly of FIG. 7D. FIG. 7C is a top view of screening material of the screen assembly of FIG. 7D.

FIG. 8 is a side exploded view of a screen assembly according to the present invention.

FIG. 9 is a perspective view of a shale shaker with a screen assembly according to the present invention.

FIG. 10 is a schematic view of a method for making a screen combination according to the present invention.

FIGS. 11 and 12 are side schematic views of movement systems used in methods according to the present invention.

### DESCRIPTION OF EMBODIMENTS PREFERRED AT THE TIME OF FILING FOR THIS PATENT

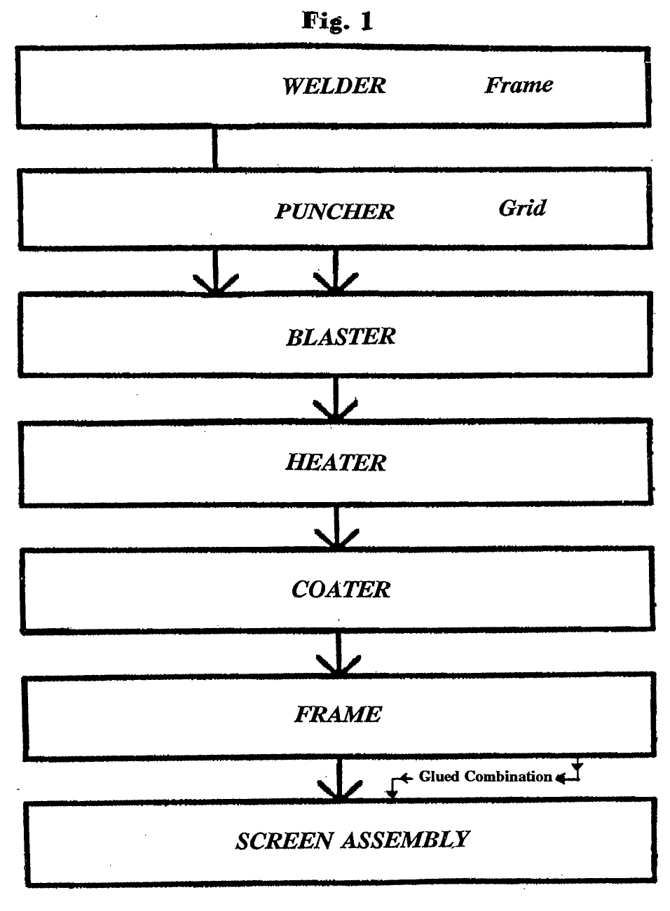

FIG. 1 shows a diagram with steps of a method according to the present invention. Parts or pieces of suitable size and dimensions to be made into a frame for a screen assembly are positioned on a support or jig adjacent a robotic welder (“WELDER”) and the support is then placed in position for welding by the robotic welder. The welder welds the parts together producing the frame which is then moved and connected to a movement system.

Optionally, a support grid can, according to the present invention, be provided which is connected to the frame. In one aspect the support grid is a layer of wire mesh with, e.g. a mesh size, in certain aspects, between 4 and 30 mesh. In another aspect the grid is any suitable known perforated plate or strip support used for screen assemblies for shale shakers and vibratory separators. In one particular aspect a metal sheet (e.g. mild steel or stainless steel) is punched by a puncher system (“PUNCHER”) and the completed plate is secured to the frame. The completed plate can be manually handled and moved onto a support of the puncher system or it can be placed thereon by a machine.

A frame or a frame-grid or frame-plate combination is moved by the movement system to a cleaning system (“BLASTER”) which cleans the frame or frame-grid combination or frame-plate combination to facilitate further processing. In one particular aspect a sand-blasting system is used to produce a clean frame or frame-grid or frame-plate combination with a smooth finish. Optionally, a frame or frame-grid combination is cleaned with cleaning fluids, e.g. degreasers, soap and/or solvents and/or which are applied by a high pressure washing system or cleaning apparatus automatically or by hand. Optionally, a perforated plate or strip support is made and cleaned separately.

A cleaned frame or frame-grid combination or frame-plate combination is then moved by the movement system to a heating system (“HEATER”) and heated as a step in a sub-process for applying powderized epoxy material thereto in a coating system (“COATER”). In one aspect a known fluidized bed system is used to apply the powderized material. Any known epoxy material for the production of such screen assemblies may be used. Any suitable known heating system, induction heater, or oven may be used. Typically, the frame or frame-grid combination or frame-plate combination is heated for 7 to 13 seconds and, in one aspect, for about 10 seconds up to a temperature of at least 400° F. and, in one aspect about 450° F. and is then, as quickly as possible, introduced into the coating system. Following cooling that results in hardening of the epoxy material, a resulting frame or frame-grid combination or frame-plate combination (“FRAME”) has one, two, three or more layers of wire mesh and/or screening material applied to it and/or connected to it producing a screen assembly (“SCREEN ASSEMBLY”) according to the present invention. Any known wire mesh or screening material or combination of layers thereof may be used. When multiple layers of screening material (and/or wire mesh) are used, they may be unconnected or they may be connected together in any known way, e.g., by bonding, gluing, sewing, adhering together, and/or fastening. Optionally, in certain particular aspects the multiple layers are glued together by methods disclosed in: U.S. Pat. No. 6,565,698 issued May 20, 2003; U.S. Pat. No. 6,450,345 issued Sep. 17, 2002; and U.S. applications Ser. No. 10/087,025 filed Oct. 19, 2001; Ser. No. 10/037,474 filed Oct. 19, 2001; Ser. No. 10/050,690 filed Jan. 16, 2002; and Ser. No. 10/210,891 filed Jul. 31, 2002—all such patents and applications incorporated fully herein for all purposes.

In certain aspects the time required to proceed from the cleaning step to the cooling step is about two minutes.

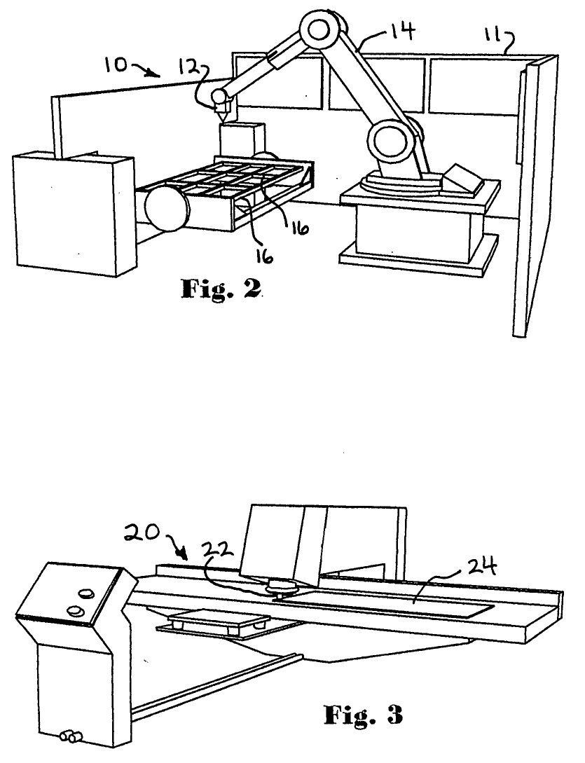

FIG. 2 shows a robotic welding system 10 in an enclosure 11 with a welding head 12 on a movable arm 14 for welding frame pieces 16. The frame pieces 16 are supported by a support 18. Robotic welding systems are commercially available.

FIG. 3 shows a puncher system 20 with a punch device 22 punching a steel plate 24.

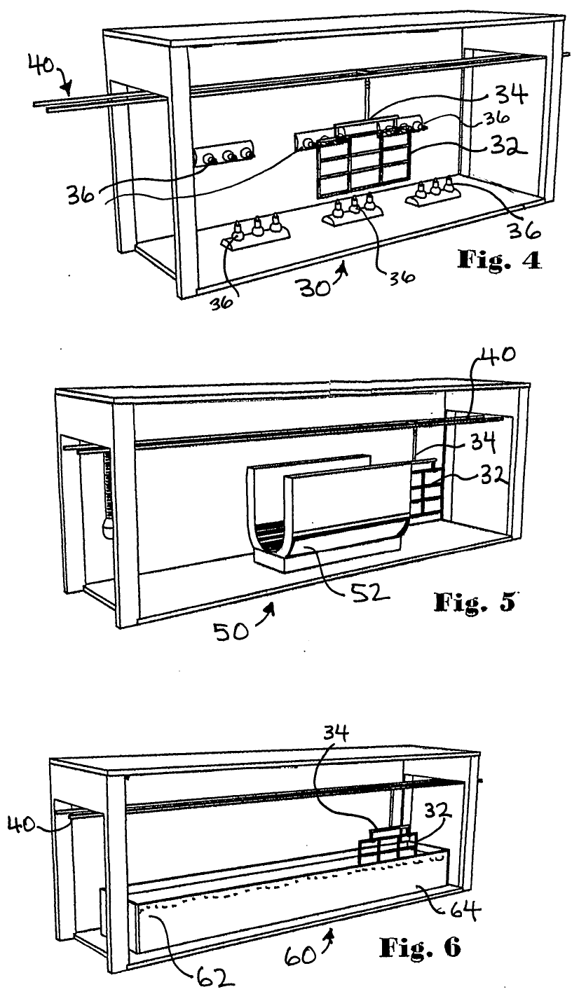

FIG. 4 shows a sandblasting system 30 for cleaning a frame 32 produced by the robotic welding system 10. The frame 32 is releasably suspended from a holder 34 of a movement system 40. Sandblasting material from nozzles 36 cleans the frame 32.

As shown in FIG. 5 the movement system 40 has moved the cleaned frame 32 to a heating system 52.

FIG. 6 shows a powdering system 60 for applying powderized epoxy material 62 in a container 64 to the heated frame

The movement system 40 moves the frame 32 through the mass of the powderized epoxy material so that the material adheres to the heated frame. The frame is initially lowered into the container 64 and then is moved through the material contained therein which, due to the heating of the frame 32, adheres thereto. Following exit of the frame 32 from the container 64, the epoxy material hardens and the finished frame 32 may be used in screen assemblies. Alternatively, suitable powderized or particulate material is sprayed onto the frame 32, e.g., in one aspect, to a thickness on a side that is to be bonded to another member (e.g. coarse wire mesh, perforated plate) of about 20 to 25 mils and on other parts and surfaces to a thickness between 5 and 15 mils. A perforated plate or strip support has similar thicknesses of material sprayed thereon.

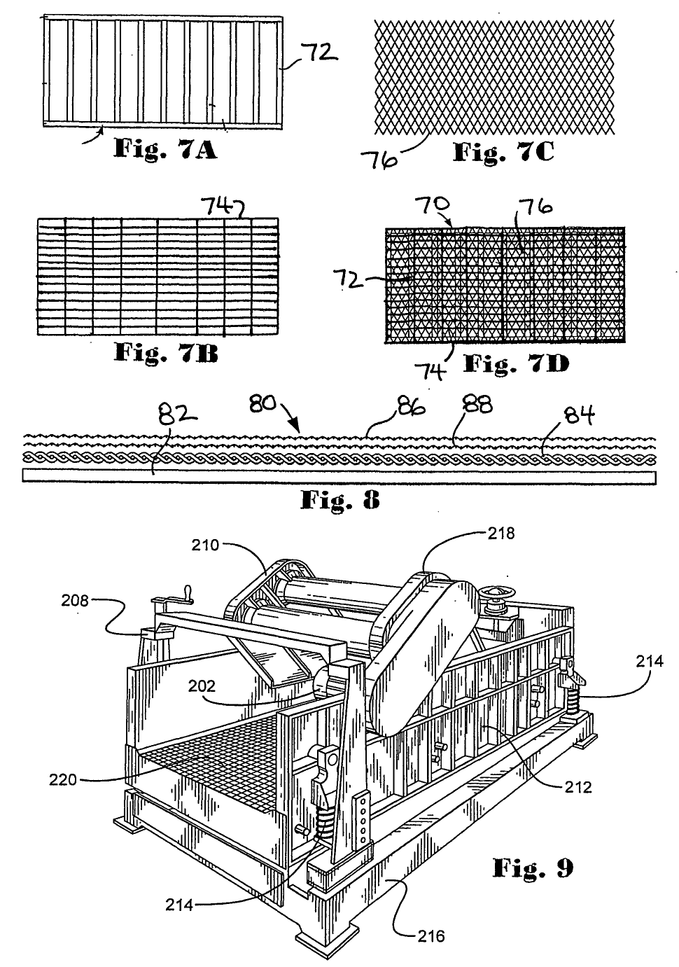

FIG. 7D shows a screen assembly 70 according to the present invention made with methods according to the present invention disclosed herein. A frame 72, FIG. 7A, (like the frame 32) has, optionally, a grid 74, FIG. 7B, connected thereto. In certain aspects the grid 74 is any suitable known coarse mesh or perforated plate. The grid 74 may be made with a puncher system, e.g. as in FIG. 3. FIG. 7C illustrates a layer of screening material 76 which is connected to the frame 72, the grid 74 or to both. Any desired number of layers of screening material, including, but not limited to, any disclosed or referred to herein, may be used.

FIG. 8 shows, in an exploded view, a screen assembly 80 according to the present invention made with methods disclosed herein which has a lower frame 82 (in certain aspects like the frames 32, 72) with a layer of coarse mesh 84 thereon and connected thereto. Two layers of screening material 86, 88 are on the coarse mesh layer 84.

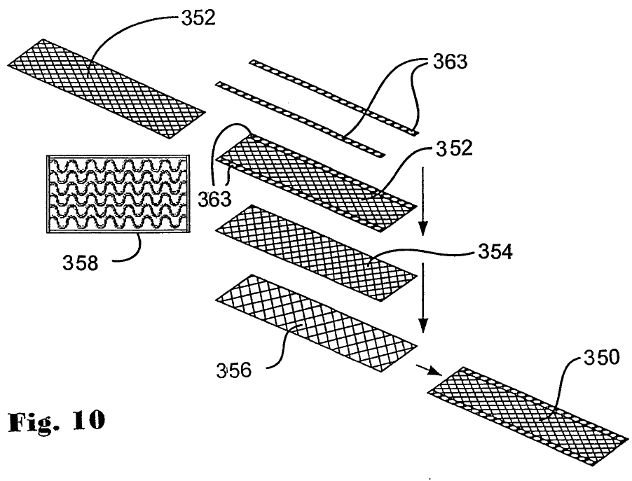

Referring now to FIG. 9, a shale shaker 210 according to the present invention has a screen assembly 220 (with screen or screening cloth or mesh as desired) according to the present invention mounted on vibratable screen mounting apparatus or “basket” 212. The screen assembly 220 may be any screen assembly disclosed herein or have any combination of any feature or features of any screen, screen assemblies or screen part disclosed herein according to the present invention; and any such screen may be used with any appropriate known shaker or screening apparatus including, but not limited to, vibratory separators and a vibratory separator like the shale shaker 210. The basket 212 is mounted on springs 214 (only two shown; two as shown are on the opposite side) which are supported from a frame 216. The basket 212 is vibrated by a motor 202 and interconnected vibrating apparatus 218 which is mounted on the basket 212 for vibrating the basket and the screens. Elevator apparatus 208 provides for raising and lowering of the basket end. The screen assembly 220 may be any screen assembly disclosed herein according to the present invention.

FIG. 10 shows a screening material combination 350 for a screen assembly according to the present invention. In one aspect the screening material combination is made by methods disclosed in pending U.S. application Ser. No. 10/236,050 filed Sep. 5, 2002 (incorporated fully herein for all purposes). A piece of screening material 352 of relatively fine mesh (e.g., but not limited to, 24 mesh to 500 mesh; made, e.g., of metal, steel, stainless steel, natural fiber such as cotton, or synthetic material such as nylon, polyester, polypropylene, polyethylene, or KEVLAR™ material) is combined with a piece of screening material 354 of a medium mesh (e.g., but not limited to, 32 mesh to 400 mesh made, e.g. of the materials as for piece 352) and a piece of screening material 356 of coarse mesh (e.g., but not limited to, 1 mesh to 30 mesh made, e.g., of the materials as for piece 352). It is within the scope of this invention to add an additional layer of screening material as any of the pieces 352, 354, 356 and to position it on top of any of the other pieces present. It is within the scope of this invention to delete any of the pieces 352, 354, or 356. The straight sides of the glue pattern 358 may be deleted.

Optionally a glue pattern, e.g. as in the glue pattern 358 is applied to the screening material piece 352. Alternatively, or additionally, such a glue pattern is applied to piece 354 and/or piece 356. Glue (or any suitable plastic, flexible adhesive, or fusible material) in any pattern or configuration may be used for the glue pattern. In certain aspects a glue pattern is applied over substantially the entire area of piece(s) of screening material, in one aspect to coincide with a stitching pattern. Glues and materials that may be used include any known in the art, any disclosed above, and, PUR glues, polyethylene, rubber, nylon, plastic, polyurethane, silicone, any suitable adhesive and epoxy. Optionally a piece of solid plastic corresponding to the stitching pattern, with or without perforations over its surface area, is used instead of or in addition to a glue pattern. Any glue, epoxy, or other adhesive may be used solely to prevent tearing; or it may also, in certain aspects, be applied in such a manner that it also bonds screening layers together and/or to a lower plate, frame, or support. A solid plastic piece may be molded with perforations or the perforations may be made after the piece is made.

Optionally strips 363 of screening material may be applied along edges of the piece 352 (and/or along edges of any of the other pieces 354, 356) for a purpose described in detail below. The strips 363 are also shown on the piece 352.

The combined structure 350 (including pieces 352, 354, 356) is glued or bonded together or sewn together in any manner as described herein using any stitch or sewing pattern as described herein. In one aspect, the stitching follows the glue pattern 358 with the needle or needles piercing the glue. Such a structure, without further processing, is substantially flat and may be used in a substantially flat screen assembly. It is within the scope of this invention to sew together only the pieces 352, 354 or 356 and to glue or bond the other piece to them.

FIG. 11 shows a mechanical movement system 100 which has a moving carrier, e.g. a chain or belt, 103 which moves on shafts 104, 105 and is rotated by shaft 105 which itself is rotated by a power system 106 connected thereto. Releasably suspended from the carrier 103 are four frames (or frame-grid or frame-plate etc. combinations) 120-123. The frame 123 has moved through a cleaner 112 and a heater 113 (e.g. like those described above); has been coated in a coated 114; and is ready to be removed from the carrier 103. The frame 123 is ready to be moved out of the coater 114. A frame 122 has been heated in the heater 113 and is ready to be moved into the coater 114. A frame 121 has been cleaned or blasted in the cleaner 112 and is ready to be moved into the heater 113. A frame 120 has been made by a robotic welder 111; connected to the carrier 103; and is ready to be moved to the cleaner 112. Controls 107 control the activation and speed of the power system 106 so that frames are moved from one apparatus to another.

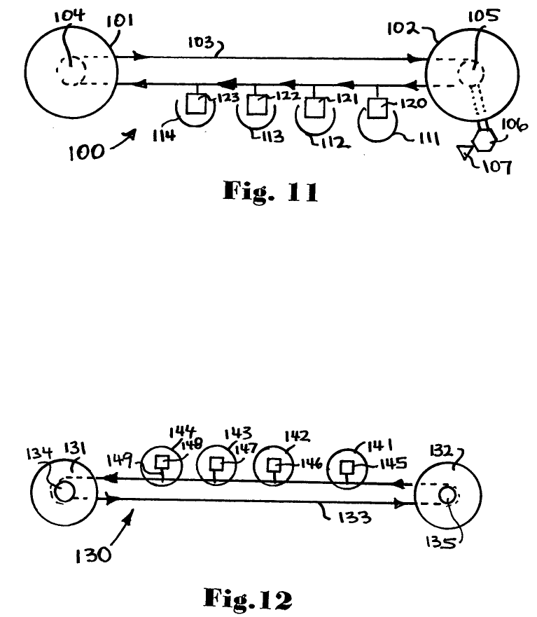

FIG. 12 shows schematically a mechanical movement system 130 which has a movable belt 133 which is mounted on shafts 134, 135. A suitable power system and controls, e.g. like those of the system 100, are used with the system 130. Frames 145-148 are on the belt 133 and are, optionally, releasably mounted on supports 149. The frames move successively from a welder 141 through cleaner apparatus 142, heater apparatus 143, and coating apparatus 144.

The present invention, therefore, provides, in at least certain embodiments, a method for making a frame for a screen assembly for a vibratory separator the method including making a frame support for a screen assembly for a vibratory separator with robotic welding apparatus, moving the frame support to cleaning apparatus, cleaning the frame support with the cleaning apparatus, moving manually and/or with mechanical movement apparatus the frame support to heating apparatus, heating the frame support with the heating apparatus, moving the heated frame support to coating apparatus with mechanical movement apparatus, coating the frame support in the coating apparatus with protective material, and allowing the coated frame support to cool so that the protective material sets. Such a method may have one or some, in any possbile combination, of the following: wherein the protective material is epoxy; wherein the cleaning apparatus is sand blasting apparatus or liquid cleaning apparatus; wherein the frame support is made of tubular members, either hollow or solid; emplacing a grid adjacent the frame support; connecting the grid to the frame support; producing the grid by punching with robotic punching apparatus a palte or piece for supporting screening material; wherein automated movement apparatus moves the frame support between any tow steps and/or from step to step; wherein automated movement apparatus moves the grid from the punching step to the cleaning apparatus; connecting a secondary support to the frame support; and/or wherein the secondary support is from the group consisting of perforated plate and strip support.

The present invention, therefore, provides, in at least certain embodiments, a method for making a screen assembly for a vibratory separator the method including making a frame support [usinga ny method disclosed above] and combining screening material with the frame support. Such a screen assembly may hoave one or some, in any possible combination, of the following: wherein the screening material comprises a plurality of layers of screening material; wherein the layers of the plurality of layers of screening material are connected together; wherein the layers are connected together by a method from the group consisting of bonding, sewing, gluing, and adhering; wherein the screening material is combined with the frame support by a method from the group consisting of fastening, welding, gluing, adhering, and bonding; connecting a grid to the frame support; wherein the grid is from the group consisting of coarse mesh layer, perforated plate, and strip support; and/or wherein the screening material is a first layer of screening material and a second layer of screening material, the method further including placing the first layer of screening material below a glue application apparatus for applying heated initially flowable hot melt glue, the first layer of screening material made of metal, and including a first metal mesh through which liquid in the fluid is passable and having a first metal mesh pattern, applying with the glue apparatus an amount of heated hot melt glue in a pattern to the top surface of the first layer of screening material, positioning a second layer of screening material adjacent and in contact with the first layer to which glue has been applied gluing together the first layer and the second layer, the second layer of screening material made of metal and including a second metal mesh through which liquid in the fluid is passable, and wherein the pattern of applied glue is different from the first metal mesh pattern.

The present invention, therefore, provides, in at least certain embodiments, a vibratory separator having screen assembly holding apparatus, vibrating apparatus for imparting vibration to the screen assembly apparatus, and the screen assembly apparatus as any disclosed herein and/or with a frame support made by any method disclosed herein.

The present invention, therefore, provides, in at least certain embodiments, a method for treating fluid with a vibratory separator, the method including introducing the fluid to the vibratory separator, the vibratory separator having screen assembly holding apparatus, vibrating apparatus for imparting vibration to the screen assembly apparatus, and the screen assembly apparatus made by any method disclosed herein, and processing the fluid with the vibratory separator.

In conclusion, therefore, it is seen that the present invention and the embodiments disclosed herein and those covered by the appended claims are well adapted to carry out the objectives and obtain the ends set forth. Certain changes can be made in the subject matter described, shown and claimed without departing from the spirit and the scope of this invention. It is realized that changes are possible within the scope of this invention and it is further intended that each element or step recited in any of the following claims is to be understood as referring to all equivalent elements or steps. The following claims are intended to cover the invention as broadly as legally possible in whatever form its principles may be utilized.

What is claimed is:

1. A method for making a frame for a screen assembly for a vibratory separator the method comprising
making a frame support for a screen assembly for a vibratory separator with robotic welding apparatus,
moving the frame support to cleaning apparatus,
cleaning the frame support with the cleaning apparatus,
moving with mechanical movement apparatus the frame support to heating apparatus,
heating the frame support with the heating apparatus,
moving the heated frame support to coating apparatus with mechanical movement apparatus,
coating the frame support in the coating apparatus with protective material, and
allowing the coated frame support to cool so that the protective material sets.

2. The method of claim 1 wherein the protective material is epoxy.

3. The method of claim 1 wherein the cleaning apparatus is sand blasting apparatus or liquid cleaning apparatus.

4. The method of claim 1 wherein the frame support is made of tubular members.

5. The method of claim 1 further comprising
emplacing a grid adjacent the frame support.

6. The method of claim 5 further comprising
connecting the grid to the frame support.

7. The method of claim 5 further comprising
producing the grid by punching a piece of material with robotic punching apparatus.

8. The method of claim 1 wherein automated movement apparatus moves the frame support from step to step.

9. The method of claim 7 wherein automated movement apparatus moves the grid to the cleaning apparatus.

10. The method of claim 1 further comprising
connecting a secondary support to the frame support.

11. The method of claim 10 wherein the secondary support is from the group consisting of perforated plate and strip support.

12. A method for making a screen assembly for a vibratory separator the method comprising
making a frame support for a screen assembly for a vibratory separator,
moving with mechanical movement apparatus the frame support to cleaning apparatus,
cleaning the frame support with the cleaning apparatus,
moving with mechanical movement apparatus the frame support to heating apparatus,
heating the frame support with the heating apparatus,
moving the heated frame support to coating apparatus with the mechanical movement apparatus,
coating the frame support in the coating apparatus with protective material,
moving the frame support away from the coating apparatus with the mechanical movement apparatus,
allowing the coated frame support to cool so that the protective material sets, and
combining screening material with the frame support.

13. The method of claim 12 wherein the screening material comprises a plurality of layers of screening material.

14. The method of claim 13 wherein the layers of the plurality of layers of screening material are connected together.

15. The method of claim 14 wherein the layers are connected together by a method from the group consisting of bonding, sewing, gluing, and adhering.

16. The method of claim 12 wherein the screening material is combined with the frame support by a method from the group consisting of fastening, welding, gluing, adhering, and bonding.

17. The method of claim 12 further comprising connecting a grid to the frame support.

18. The method of claim 17 wherein the grid is from the group consisting of coarse mesh layer, perforated plate, and strip support.

19. The method of claim 17 wherein the screening material comprises a first layer of screening material and a second layer of screening material, the method further comprising
placing the first layer of screening material below a glue application apparatus for applying heated initially flowable hot melt glue, the first layer of screening material made of metal, and comprising a first metal mesh through which liquid in the fluid is passable and having a first metal mesh pattern,
applying with the glue apparatus an amount of heated hot melt glue in a pattern to the top surface of the first layer of screening material,
positioning a second layer of screening material adjacent and in contact with the first layer to which glue has been applied gluing together the first layer and the second layer, the second layer of screening material made of metal and comprising a second metal mesh through which liquid in the fluid is passable, and
wherein the pattern of applied glue is different from the first metal mesh pattern.

20. A screen assembly made by the method of claim 12.

21. A frame support made by the method of claim 1.

22. A vibratory separator comprising
screen assembly holding apparatus,
vibrating apparatus for imparting vibration to the screen assembly apparatus, and
the screen assembly apparatus made by the method of claim 12.

23. A method for treating fluid with a vibratory separator, the method comprising
introducing the fluid to the vibratory separator, the vibratory separator comprising screen assembly holding apparatus, vibrating apparatus for imparting vibration to the screen assembly apparatus, and the screen assembly apparatus made by the method of claim 12, and
processing the fluid with the vibratory separator.
